(19) United States
(12) Patent Application Publication
(10) Pub. No.: US 2021/0170855 A1
(43) Pub. Date: Jun. 10, 2021

(54) Drive train unit for a hybrid vehicle having axial compensation

(71) Applicant: Schaeffler Technologies AG & Co. KG, Herzogenaurach (DE)

(72) Inventors: Thomas Hurle, Bühlertal (DE); Ivo Agner, Bühl (DE); Aurelie Keller, Herrlisheim (FR)

(73) Assignee: Schaeffler Technologies AG & Co. KG, Herzogenaurach (DE)

(21) Appl. No.: 16/973,812

(22) PCT Filed: May 10, 2019
(86) PCT No.: PCT/DE2019/100424

§ 371 Date: Dec. 10, 2020

(30) Foreign Application Priority Data
Jun. 22, 2018 (DE) 10 2018 115 091.1
Apr. 10, 2019 (DE) 10 2019 109 434.8

(51) Int. Cl. B60K 6/36; B60K 6/26; B60K 6/38; F16D 21/00; F16H 57/021; F16D 3/12

(52) U.S. Cl. CPC B60K 6/36; B60K 6/26; B60K 6/38; B60K 6/24; F16H 57/021; F16D 3/12; F16D 21/00

(57) ABSTRACT

A drive train unit for a motor vehicle includes a housing and an input shaft rotatably mounted in the housing and arranged for attachment to an output of a transmission in a rotationally fixed manner. The input shaft has a first input shaft section and a second input shaft section that can move axially in relation to the first input shaft section. The drive train unit may include an electric machine arranged parallel to the input shaft, and a first clutch. The electric machine has a rotor and the first clutch arranged to connect the rotor and the input shaft for torque transmission in a shift position. The drive train may include an output shaft rotatably mounted in the housing and arranged for rotational coupling to a distributer transmission, and a second clutch arranged to connect the input shaft and the output shaft for torque transmission in a shift position.

### CROSS-REFERENCE TO RELATED APPLICATIONS

This application is the United States National Phase of PCT Appln. No. PCT/DE2019/100424 filed May 10, 2019, which claims priority to German Application Nos. DE102018115091.1 filed Jun. 22, 2018 and DE102019109434.8 filed Apr. 10, 2019, the entire disclosures of which are incorporated by reference herein.

### TECHNICAL FIELD

The disclosure relates to a drive train unit for a motor vehicle, in particular for a hybrid-drivable motor vehicle, such as a car, a truck, a bus or another utility vehicle.

### BACKGROUND

Automatic transmissions for motor vehicles are generally known from the prior art. What are termed P3 electric machines are also already known, which are arranged at a transmission output of the automatic transmission and can be coupled and uncoupled by means of a separating clutch. Another clutch ensures that an output of the transmission, in addition to its coupling with the wheels of a front axle, is optionally coupled with the wheels of a rear axle to implement an all-wheel drive.

However, the prior art has the disadvantage that large axial movements and/or high forces occur at the output of the transmission due to the helically toothed spur gears. The movements and/or forces are dependent on a helix angle, a helix direction and thus gear, temperature and torque, because there is a large axial backlash in the bearings.

### SUMMARY

The disclosure provides a drive train unit in which the vibrations and forces arising from the bearing in the automatic transmission are not passed on by the drive train unit, e.g., not transmitted to the clutches.

Example embodiments include a drive train unit for a motor vehicle, having a housing, an input shaft rotatably mounted in the housing, which is prepared for rotationally fixed attaching to an output of a transmission, and an optional electric machine which is arranged to be axially parallel to the input shaft. The drive train also includes a first clutch which connects a rotor of the electric machine and the input shaft for torque transmission in a shift position, an optional output shaft rotatably mounted in the housing, which is prepared for rotational coupling to a distributer transmission, and a second clutch which connects the input shaft and the output shaft for torque transmission in a shift position. The input shaft has a first input shaft section and a second input shaft section that can move axially in relation to the first input shaft section.

An axial movement between the two input shaft sections and thus between the bearing contact positions is permitted so that the axial movement caused by the helically toothed spur gears can be compensated for and is therefore not passed on to the clutches. This means that the axial movement introduced into the second input shaft section is not passed on to the first input shaft section.

The input shaft between the output of the transmission and one of the two clutches, i.e., and the first clutch or the second clutch, may be separated into the first input shaft section and the second input shaft section. Consequently, the resulting vibrations and forces are not introduced axially into the first clutch and the second clutch and thus into the module structure.

In addition, the second input shaft section may be connected to the first input shaft section in a torque-transmitting manner in order to achieve rotational rigidity with an axial softness. This ensures torque transmission from the output of the transmission to the output shaft of the drive train unit via the input shaft. An axial movement is therefore decoupled from the torque transmission. In addition, the axial softness of the connection between the two input shaft sections ensures that the reaction forces caused by the axial displacement are rather low and can thus be supported via a bearing.

According to an example embodiment, the second input shaft section can have a leaf spring assembly for realizing the axial softness, by means of which the second input shaft section is connected to the first input shaft section. In this way, the function of the torque transmission can be ensured and the function of the axial travel compensation can be realized in particular via an axially very soft leaf spring assembly. The leaf spring assembly may be designed for a torque of 800 to 1200 Nm, e.g., 950 to 1050 Nm. The spring stiffness (in the axial direction) of the leaf spring assembly may be between 100 and 200 N/mm, e.g., 130 to 170 N/mm.

The leaf spring assembly can have a plurality of leaf springs, for example four leaf springs each, which are arranged in the same sense as one another. This ensures that the leaf springs do not adversely affect one another with regard to axial travel compensation. For example, the leaf spring assembly can have a thickness of 0.5 to 1 mm. The leaf springs may be arranged almost or largely or substantially tangentially in the circumferential direction.

The leaf spring assembly may be buckling-resistant in one direction. This means that the leaf spring assembly is designed for a buckling torque of at least 1500 Nm, e.g., from 1600 to 1700 Nm. This ensures the transmission of torque in pulling and/or pushing operation. For example, there may be several leaf spring assemblies evenly distributed over the circumference. In this way, the force of the leaf springs can be evenly distributed over the circumference.

The leaf spring assembly may be arranged on a pitch circle of at least 80 mm, e.g., from 90 to 120 mm. The leaf spring assembly may be arranged radially inside of friction plates of the first clutch and/or radially outside of a clutch bearing of the first clutch.

The second input shaft section may be arranged to be centered in the radial direction with respect to the first input shaft section. This avoids radial misalignment between the two input shaft sections and simplifies installation. For example, the second input shaft section can have a centering section formed on a hub section, which is centered on a radial centering projection formed on the first input shaft section.

The leaf spring assembly can be fastened to the first input shaft section in a centered and axially non-pretensioned state, e.g., during the installation of this assembly, for example via a riveting. This supports the centered alignment of the two shaft sections with one another. In other words, the leaf spring assembly is installed in a flat or unbuckled state or in a rest position.

The first input shaft section may be firmly connected to a clutch component of the first clutch or the second clutch. This means that the first input shaft section forms a part of the input shaft on the output side, and the division takes place between the first clutch and the output of the transmission.

The second input shaft section may have a spline which is provided to be attached to the output of the transmission in a rotationally fixed manner. The spline may be lubricated. This lubrication point may be sealed via a sealing ring so that the lubricant cannot penetrate into the transmission or the drive train unit. Since the spline axially blocks when torque is transmitted and therefore does not allow axial travel compensation, the spline, in combination with the leaf spring connection, permits an axial movement that is almost hysteresis-free and the torque is transmitted at the same time.

In other words, a hybrid transmission (transmission unit) is provided which has an (automatic) transmission and an electric machine which is axially offset therefrom and is arranged at an output of the transmission. The electric machine can be coupled/decoupled to/from a drive train using a separating clutch. In addition, a further (second) clutch can optionally be provided, which is designed for coupling/decoupling a drive shaft (output shaft) connected to a distributer transmission. The electric machine and the at least one clutch or the two clutches together form a module. In other words, the disclosure relates to a drive train unit in which an input shaft is separated between a transmission and a separating clutch (the first clutch). The two parts of the input shaft, which are designed separately from one another, are connected to one another in the circumferential direction via leaf springs in order to provide compensation for an axial offset/axial movement.

### BRIEF DESCRIPTION OF THE DRAWINGS

The disclosure is explained below with the aid of a drawing. In the figures:

FIG. 1 shows a longitudinal representation of an example of a drive train unit,

FIG. 2 shows a longitudinal representation of a drive train unit according to the invention,

FIG. 3 shows an enlarged representation of a section from FIG. 2, and

FIG. 4 shows a perspective representation of a vibration damper.

### DETAILED DESCRIPTION

The figures are only schematic in nature and serve only for understanding the disclosure. The same elements are provided with the same reference symbols. The features of the exemplary embodiments can be interchanged.

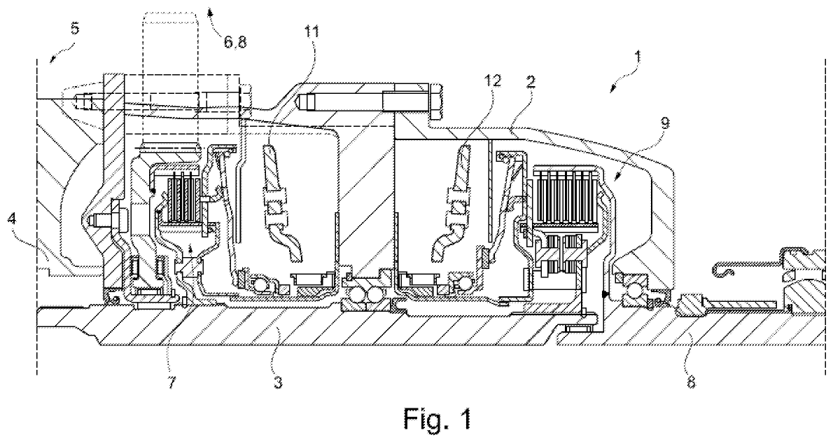

FIG. 1 shows an example of a drive train unit 1 for a hybrid vehicle. The drive train unit 1 has a housing 2. An input shaft 3 is rotatably mounted in the housing 2. The input shaft 3 is provided to be attached to an output 4 of a transmission 5 in a rotationally fixed manner. The transmission 5 is only indicated in terms of its position. The drive train unit 1 is operatively connected to the transmission 5 and forms a transmission unit with the transmission. The transmission 5 is implemented as an automatic transmission. The output 4 of the transmission 5 is connected to the input shaft 3 in a rotationally fixed manner (in the form of a transmission output shaft). The output 4 may be connected to the input shaft 3 in a rotationally fixed manner via a toothing.

The transmission unit may be used in a drive train of a hybrid all-wheel drive vehicle. The transmission 5 is operatively connected on the input side to an internal combustion engine in a typical manner. The drive train unit 1 is inserted between the transmission 5 and a Cardan shaft, which is also connected to a distributer transmission on a rear axle of the motor vehicle.

The drive train unit 1 can have an electric machine 6, which is only indicated in principle with regard to its position. The electric machine 6 is arranged to be axially parallel to the input shaft 3. The drive train unit 1 can have a first clutch 7, which is also referred to as a separating clutch. In one switching position, the first clutch 7 connects a rotor 8 of the electric machine 6 and the input shaft 3 for torque transmission. The rotor 8, which is only indicated with regard to the position, can therefore be switchably connected to the input shaft 3 in a rotationally fixed (or rotationally coupled) manner.

The drive train unit 1 can have an output shaft 8 which is rotatably supported in the housing 2. The output shaft 8 is provided for rotational coupling with the distributer transmission. For this purpose, the Cardan shaft is connected in a rotationally fixed manner to the output shaft 8 of the drive train unit 1. The drive train unit 1 can have a second clutch 9, which is also referred to as an all-wheel clutch. In one switching position, the second clutch 9 connects the input shaft 3 and the output shaft 8 for torque transmission. The output shaft 8 can therefore be switchably connected to the input shaft 3 in a rotationally fixed manner.

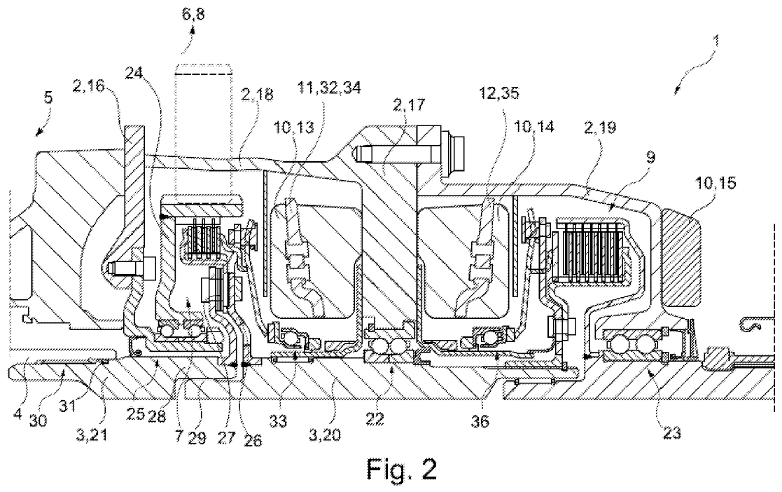

FIG. 2 shows a drive train unit 1 according to the disclosure. The drive train unit 1 according to the disclosure has the features described above in connection with FIG. 1.

The drive train unit 1 according to the disclosure has at least one vibration damper 10 attached to the housing 2. The vibration damper 10 is attached inside the housing 2. The vibration damper 10 is coordinated with a clutch actuation unit 11 of the first clutch 7 and/or with a clutch actuation unit 12 of the second clutch 9 in such a way that a common installation space inside the housing 2 is used.

In the embodiment represented, two vibration dampers 10 are mounted in the housing 2. A first vibration damper 13 is matched to the clutch actuation unit 11 of the first clutch 7, so that a common installation space inside the housing 2 is used. A second vibration damper 14 is matched to the clutch actuation unit 12 of the second clutch 8, so that a common installation space inside the housing 2 is used. A further vibration damper 15 is attached to the housing 2. The further vibration damper 15 is attached outside of the housing 2.

The housing 2 has a flange 16 that forms the housing 2, a partition 17, a first housing section 18 and a second housing section 19. The partition 17 essentially separates a first housing area, in which the first clutch 7 is arranged, and a second housing area, in which the second clutch 9 is arranged, from one another. The first housing area is essentially delimited by the flange 16, the partition 17 and the first housing section 18. The second housing area is essentially delimited by the partition 17 and the second housing section 19.

The first vibration damper 13 is attached to the partition 17. The first vibration damper 13 is arranged in the first housing area. The second vibration damper 14 is attached to the partition 17. The second vibration damper 14 is arranged in the second housing area. The further vibration damper 15 is attached to the second housing section 19.

As described above, the drive train unit 1 according to the disclosure has the input shaft 3. The drive train unit 1 in FIG. 2 has a separated input shaft 3 which is formed by a first input shaft section 20 and a second input shaft section 21. The first input shaft section 20 is arranged to be axially displaceable relative to the second input shaft section 21. For this purpose, the first input shaft section 20 and the second input shaft section 21 are designed as shafts that are separate from one another. The first input shaft section 20 is supported on a radial inside of the partition 17 via a first support bearing 22, which is designed here as a double ball bearing/double row deep groove ball bearing. The output shaft 8 is supported on a hub section of the housing 2 that is fixed to the partition wall via a second support bearing 23, designed here as a roller bearing. The first clutch 7 has a first clutch component and a second clutch component. The second clutch component is permanently connected to the first input shaft section 20 in a rotationally fixed manner.

The first clutch 7 is rotationally coupled to the rotor 8 of the electric machine 5 with the first clutch component. The first clutch component has a plurality of first friction plates, which are typically connected to a plurality of second friction plates of the second clutch component of the first clutch 7 in a rotationally fixed manner (closed position) or are rotationally decoupled therefrom (open position) for the design as a friction plate clutch. The first and second friction plates are arranged alternately with one another in the axial direction. The first clutch 7 is moved back and forth between its closed position and its open position by the clutch actuation unit 11 of the first clutch 7.

The first clutch component also has a (first) carrier 24 which is rotatably mounted relative to the housing 2. For this purpose, the first carrier 24 has a bearing base on its radial inside, which is supported in the axial direction and in the radial direction on the housing 2, in particular the flange 16, via a clutch bearing 25 designed as a double ball bearing/double row deep groove ball bearing. From this bearing base, the first carrier 24 extends in a substantially disk-shaped manner radially outward with respect to the axis of rotation of the drive train unit 1. On a radial outer side, the first carrier 24 forms a toothing (external toothing) which is used for the rotationally fixed coupling with the rotor 8. To couple the rotor 8 to the first carrier 24, a gear stage is provided. A toothed wheel shown in dashed lines is permanently in mesh with the toothing. The gear wheel is directly connected to the rotor 8 in a rotationally fixed manner and is thus arranged coaxially to the rotor 8.

A (first) receiving area is provided on the first carrier 24 radially within the toothing and is used directly for receiving the first friction plates in a rotationally fixed manner. In addition, the first friction plates are received on the first receiving area so as to be displaceable relative to one another in the axial direction. The first friction plates are arranged towards a radial inside of the first receiving area, so that the first carrier 24 forms an outer plate carrier of the first clutch 7. The first carrier 24 extends in such a way that the first friction plates are arranged in the radial direction outside the bearing base and radially inside the toothing. The second clutch component is permanently coupled to the input shaft 3 in a rotationally fixed manner. For this purpose the second clutch component has a (second) carrier 26. The second carrier 26 is connected to the first input shaft section 20 in a rotationally fixed manner. The second carrier 26 has a (second) receiving area extending in the axial direction, on the radial outer side of which the second friction plates are arranged in a rotationally fixed manner and can also be displaced relative to one another in the axial direction. The second carrier 26 thus forms an inner plate carrier of the first clutch 7.

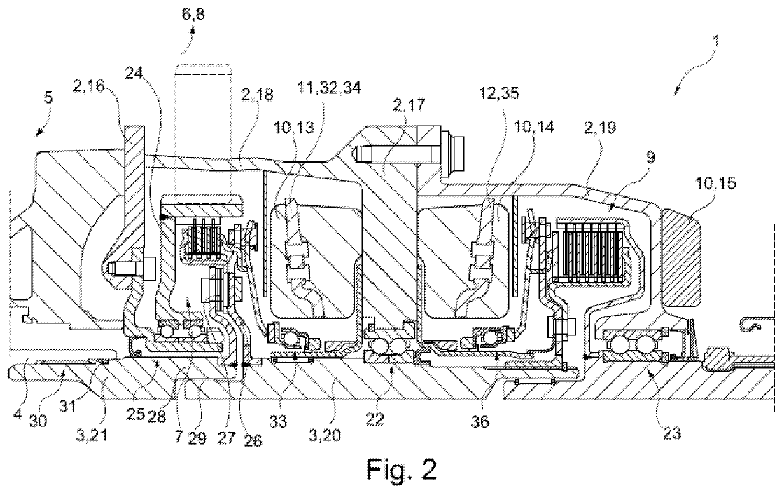

The second input shaft section 21 has a leaf spring assembly 27 (see also FIG. 3), by means of which the second input shaft section 21 is connected to the first input shaft section 20 in a torque-transmitting manner. The torque can be transmitted through the leaf spring assembly 27 and at the same time the first and second input shaft sections 20, 21 can move in the axial direction with respect to one another. The leaf spring assembly 27 thus realizes an axial compensation between the first and the second input shaft section 20, 21. The leaf spring assembly 27 is arranged radially inside the friction plates. The leaf spring assembly 27 is arranged radially outside of the bearing base or the clutch bearing 25. The leaf spring assembly 27 is firmly attached to the second carrier 26. For example, the leaf spring assembly 27 is connected to the first carrier 26 via a riveting. The leaf spring assembly 27 has several leaf springs arranged in the same sense. A plurality of leaf spring assemblies 27 may be distributed uniformly over the circumference, for example three leaf spring assemblies at a distance of 120°.

The second input shaft section 21 has a centering section 28, via which the second input shaft section 21 is centered with respect to the first input shaft section 20. The centering section 28 is designed as a hub section which rests on a radially protruding centering projection 29 formed on the first input shaft section 20. The leaf spring assembly 27 is connected to the second carrier 26 in the centered and straight state. The second input shaft section 21 is connected to the output 4 of the transmission 5 via a spline 30 in a rotationally fixed manner. The spline 30 is lubricated. The lubrication of the spline 30 is sealed via a sealing ring 31 between the output 4 of the transmission 5, the indicated transmission output shaft here, and the second input shaft section 21.

The clutch actuation unit 11 of the first clutch 7 is equipped with a lever actuator 32 which has an adjusting effect on a first actuation bearing 33. The first actuation bearing 33 in turn serves to shift the friction plates of the first clutch 7. The lever actuator 32 has an electric motor which cooperates with a first lever part of a lever mechanism of the first lever actuator in a driving manner. The first lever part, which can be moved in the circumferential direction, i.e., can be rotated with respect to the input shaft 3, is coupled to a second lever part 34 of the lever mechanism. Typically, the second lever part 34 is coupled to the first lever part via a ramp mechanism. The second lever part 34 is in principle coupled to the first lever part in such a way that a rotation of the first lever part leads to an axial displacement of the second lever part 34. The second lever part 34 is in turn coupled to the first actuation bearing 33 in a non-displaceable manner. The first actuation bearing 33, which is implemented here as a ball bearing, also acts on a first actuation force introduction mechanism, which is received on the second carrier 26 of the first clutch 7 and has an adjusting effect on the friction plates of the first clutch 7. In this way, an actuating/axial force can be applied to the entirety of the friction plates of the first clutch 7 in the axial direction and the first clutch 7 can be brought into its closed position.

The first actuation force introduction mechanism has a lever element. The lever element is implemented as a disk spring, for example. The lever element is received in a pivotable manner on a pivot bearing which is connected to the second carrier 26 in a fixed manner. Radially within the pivot bearing, the lever element has an adjusting effect on an actuator, which in turn has a direct sliding effect on all of the friction plates of the first clutch 7. On a side of the entirety of the friction plates of the first clutch 7 axially facing away from the actuator, a counter-support area is arranged, which counter-support area is also directly connected to the second carrier 26 in order to achieve a closed force profile in the second carrier 26 and to introduce the actuating force into the input shaft 3 via the second carrier 26.

The clutch actuation unit 12 of the second clutch 9 is equipped with a lever actuator 35 which has an adjusting effect on a second actuation bearing 36. The second actuation bearing 36 in turn serves to shift the friction plates of the second clutch 9, which is designed as a friction plate clutch. The clutch actuation unit 12 is constructed and functioning according to the clutch actuation unit 11 of the first clutch 7.

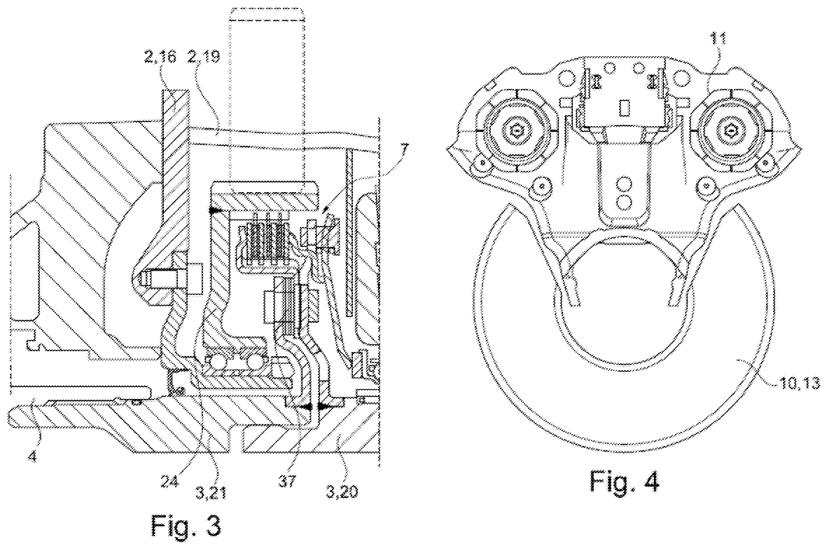

FIG. 4 shows the structure and the arrangement of the first vibration damper 13. The first vibration damper 13 is not designed to be rotationally symmetrical. The first vibration damper 13 has a cross-section that is essentially ring arch-shaped. The ring arch extends over less than 360°, e.g. over more than 180°. For example, the ring arch extends over 230 to 270°. The first vibration damper 13 is therefore limited over a certain angular range, which is less than 360°. This means that the first vibration damper 13 does not extend over the entire circumference, but is interrupted in sectors. For example, the lever actuator 32, e.g., the second lever element 34 of the lever actuator 32, is arranged in a sector of the circumference in which the first vibration damper 13 is not arranged. In other words, the clutch actuation device 11 (e.g., the second lever element 34) and the first vibration damper 13 share the installation space within the housing 2. This means that the first vibration damper 13 and the clutch actuation device 11 are arranged to overlap in the axial direction. This also means that the first vibration damper 13 and the clutch actuation device 11 are arranged to be offset in the circumferential direction, e.g., offset in sectors. In other words, the part of the first vibration damper 13 that is missing from the first vibration damper 13 for rotational symmetry essentially corresponds to the shape of the second lever element 34.

The first vibration damper 13 has a volume percentage of steel of 40 to 70%, e.g., 50 to 60% or 55%±1%. The first vibration damper 13 has a damper mass of 2 kg±0.5 kg. The first vibration damper 13 has an oscillation frequency of 110 to 140 Hz. The first vibration damper 13 can, for example, have a damper volume of 400 to 500 cm³. The construction and the arrangement of the second vibration damper 14 correspond to those of the first vibration damper 13.

The further vibration damper 15 is constructed to be rotationally symmetrical. The further vibration damper 15 has an annular cross-section. The further vibration damper 15 has a volume percentage of steel of 40 to 70%, e.g., 50 to 60% or 55%±1%. The further vibration damper 15 has a damper mass of 1 kg±0.2 kg. The further vibration damper 15 has an oscillation frequency of 110 to 140 Hz. The further vibration damper 15 can, for example, have a damper volume of 200 to 300 cm³.

### REFERENCE NUMERALS

1 Drive train unit

2 Housing

3 Input shaft

4 Output

5 Transmission

6 Electric machine

7 First clutch

8 Rotor

9 Second clutch

10 Vibration damper

11 Clutch actuation unit

12 Clutch actuation unit

13 First vibration damper

14 Second vibration damper

15 Further vibration damper

16 Flange

17 Partition

18 First housing section

19 Second housing section

20 First input shaft section

21 Second input shaft section

22 First support bearing

23 Second support bearing

24 First carrier

25 Clutch bearing

26 Second carrier

27 Leaf spring assembly

28 Centering section

29 Centering projection

30 Spline

31 Sealing ring

32 Lever actuator

33 First actuation bearing

34 Second lever element

35 Lever actuator

36 Second actuation bearing

1.-10. (canceled)

11. A drive train unit for a motor vehicle, comprising:
a housing; and
an input shaft rotatably mounted in the housing and arranged for attachment to an output of a transmission in a rotationally fixed manner, the input shaft comprising:
a first input shaft section; and
a second input shaft section that can move axially in relation to the first input shaft section.

12. The drive train unit of claim 11, wherein the second input shaft section is arranged to be centered with respect to the first input shaft section in a radial direction.

13. The drive train unit of claim 11, wherein the second input shaft section comprises a spline for attaching to the output in a rotationally fixed manner.

14. The drive train unit of claim 11, wherein the second input shaft section is connected to the first input shaft section in a torque-transmitting manner.

15. The drive train unit of claim 14 wherein the second input shaft section comprises a leaf spring assembly connecting the second input shaft section to the first input shaft section.

16. The drive train unit of claim 15, wherein the leaf spring assembly comprises a plurality of leaf springs arranged in the same sense as one another.

17. The drive train unit of claim 15, wherein the leaf spring assembly is buckling-resistant in one direction.

18. The drive train unit of claim 11 further comprising:
an electric machine arranged axially parallel to the input shaft, the electric machine comprising a rotor; and
a first clutch arranged to connect the rotor and the input shaft for torque transmission in a shift position.

19. The drive train unit of claim 11 further comprising:
an output shaft rotatably mounted in the housing and arranged for rotational coupling to a distributer transmission; and
a second clutch arranged to connect the input shaft and the output shaft for torque transmission in a shift position.

20. The drive train unit of claim 19 further comprising:
an electric machine arranged axially parallel to the input shaft, the electric machine comprising a rotor; and
a first clutch arranged to connect the rotor and the input shaft for torque transmission in a shift position.

21. The drive train unit of claim 20, wherein the second input shaft section is arranged to be centered with respect to the first input shaft section in a radial direction.

22. The drive train unit of claim 20, wherein:
the first clutch comprises a first clutch component;
the second clutch comprises a second clutch component; and
the first input shaft section is fixed to the first clutch component or the second clutch component.

23. The drive train unit of claim 20, wherein:
the first input shaft section is connected to the first clutch or the second clutch; and
the second input shaft section is arranged for attachment to the output.

24. The drive train unit of claim 20, wherein the second input shaft section is connected to the first input shaft section in a torque-transmitting manner.

25. The drive train unit of claim 20, wherein the second input shaft section comprises a spline for attaching to the output in a rotationally fixed manner.

26. The drive train unit of claim 20 wherein the second input shaft section comprises a leaf spring assembly connecting the second input shaft section to the first input shaft section.

27. The drive train unit of claim 26, wherein the leaf spring assembly comprises a plurality of leaf springs arranged in the same sense as one another.

28. The drive train unit of claim 26, wherein the leaf spring assembly is buckling-resistant in one direction.

29. The drive train unit of claim 26, wherein the leaf spring assembly is attached to the first input shaft section in a centered and axially non-pretensioned state.
